(19) United States
(12) Patent Application Publication
(10) Pub. No.: US 2025/0074265 A1
(43) Pub. Date: Mar. 6, 2025

(54) VEHICLE SEAT AND METHOD FOR USING THE SEAT

(71) Applicant: FAURECIA Sièges d'Automobile, NANTERRE (FR)

(72) Inventors: David EPAUD, LARDY (FR); Luis Filipe MARQUES ABREU, ETAMPES (FR)

(21) Appl. No.: 18/817,891

(22) Filed: Aug. 28, 2024

(30) Foreign Application Priority Data
Aug. 29, 2023 (FR) 2309035

(51) Int. Cl. B60N 2/12; B60N 2/04; B60N 2/08; B60N 2/30

(52) U.S. Cl. CPC B60N 2/12; B60N 2/045; B60N 2/08; B60N 2/309

(57) ABSTRACT

A vehicle seat comprising a squab, a slideway, a front connecting rod, a rear connecting rod, a linking rod, a latch and an elastic element, wherein: the slideway comprises a first element and a second element, the front connecting rod is rotatably mounted on the second element of the slideway about a lower front hinge axis, the rear connecting rod is rotatably mounted on the first element about a movable lower rear hinge axis, the linking rod is rotatably mounted on the front connecting rod and on the rear connecting rod, the elastic element urges the lower rear hinge axis to move, the seat is configured to move to a retracted configuration by moving the lower front hinge axis closer to the lower rear hinge axis.

### PRIORITY CLAIM

This application claims priority to French Patent Application No. FR2309035, filed Aug. 29, 2023, which is expressly incorporated by reference herein.

### BACKGROUND

The present disclosure relates to a vehicle seat and a method for using the vehicle seat.

### SUMMARY

According to the present disclosure, a vehicle seat comprises:
a squab with a front edge and a rear edge,
a slideway comprising a first element and a second element, the first element being intended to be fixed to a vehicle floor and the second element being configured to slide relative to the first element in a longitudinal direction between a forward end position and a rearward end position, in a forward direction or in a rearward direction, opposite to the forward direction,
a front connecting rod with a lower front end and an upper front end,
a rear connecting rod with a lower rear end and an upper rear end,
a linking rod with an intermediate front end and an intermediate rear end,
a latch having an active state and an inactive state, in a usage configuration of the seat the latch is in the active state and holds the squab relative to the second element of the slideway at least along the longitudinal direction, in the inactive state the latch does not hold the squab relative to the second element of the slideway, and
an elastic element.

In illustrative embodiments, in the vicinity of the lower front end, the front connecting rod is rotatably mounted about a lower front hinge axis on the second element of the slideway,
in the vicinity of the upper front end, the squab is rotatably mounted on the front connecting rod about an upper front hinge axis,
in the vicinity of the lower rear end, the rear connecting rod is rotatably mounted on the first element about a lower rear hinge axis, and the lower rear hinge axis is movable in the longitudinal direction,
in the vicinity of the upper rear end, the squab is rotatably mounted on the rear connecting rod about an upper rear hinge axis,
in the vicinity of the intermediate front end, the linking rod is rotatably mounted on the front connecting rod about an intermediate front hinge axis,
in the vicinity of the intermediate rear end, the linking rod is rotatably mounted on the rear connecting rod about an intermediate rear hinge axis,
the lower front hinge axis, the upper front hinge axis, the lower rear hinge axis, the upper rear hinge axis, the intermediate front hinge axis and the intermediate rear hinge axis extend in a transverse direction, perpendicular to the longitudinal direction,
the elastic element urges the lower rear hinge axis to move forward along the longitudinal direction,
the seat is configured to switch from the usage configuration to a retracted configuration after switching from the active state to the inactive state of the latch, by a retracting movement of the rear edge of the seat, moving the lower front hinge axis closer to the lower rear hinge axis over a retracting distance, the retracting movement comprising a forward component in the longitudinal direction.

According to a further feature in accordance with the disclosure, preferably the retracting movement comprises a rear seat access movement, the seat is configured to perform the rear seat access movement by sliding the second element from the front end position over the retraction distance in the rearward direction relative to the first element, while keeping the lower rear hinge axis along the longitudinal direction.

As a result, the slideway is not in the extreme forward position in the retracted configuration, which improves the slideway's robustness.

According to a further feature in accordance with the disclosure, the seat preferably further comprises a single actuator configured to, in the usage configuration, translate the squab in the forward direction and in the rearward direction, opposite to the forward direction, by moving the second element along the longitudinal direction, and cause the retracting movement of the rear edge of the squab by moving the second element in the rearward direction, when the latch is in the inactive state.

In this way, a single actuator can be used to set the usage configuration and the retracting movement.

According to a complementary feature in accordance with the disclosure, the seat is preferably configured so that the transition from the active to the inactive state of the latch allows emergency movement of the rear edge of the squab, by moving the lower rear hinge axis in the forward direction along the longitudinal direction while maintaining the second element relative to the first element.

In this way, even in the event of actuator failure, the seat can be placed in the retracted configuration.

According to a still further feature in accordance with the disclosure, preferably the slideway has a sliding stroke between the front end position and the rear end position, and the actuator is configured to limit the movement of the second element relative to the first element, in the usage configuration, between the rear end position and a front end setting position, the front end setting position being between the front end position and the rear end position and spaced from the front end position by the retracting distance.

In this way, whatever setting the user sets in the usage configuration, the seat can be placed in the retracted configuration, even if the actuator fails.

In various embodiments of the seat according to the disclosure, any of the following arrangements may also be employed:
the elastic element has a front loading end and a rear loading end, the front loading end is connected to the lower front hinge axis and the rear loading end is connected to the lower rear hinge axis;
in the active state, the latch holds the squab in the vicinity of the rear edge, relative to the second element;
the seat further comprises a backrest and a hinge, the backrest is connected to the squab by the hinge, the hinge has a hinge axis and is rotationally lockable, the hinge axis extends in the transverse direction in the vicinity of the rear edge;
the retracting movement further comprises moving the rear edge of the squab away from the slideway, in an elevation direction perpendicular to the longitudinal direction and the transverse direction;
the first element has a slot extending in the longitudinal direction, a slider is slidably mounted in the slot, and the rear connecting rod is mounted on the first element via the slider;
the slot has a front end forming a stop, and
in the operating configuration, in the extreme front position, the slider is in abutment with the front end of the slot;
the upper front hinge axis is close to the front edge of the seat, and the upper rear hinge axis is close to the rear edge of the seat.

The present disclosure also relates to a method of using the aforementioned seat, the method comprising, starting from the usage configuration, the following operations:
a) switching from the active to inactive state of the latch, then
b) moving the lower front hinge axis closer to the lower rear hinge axis by the retraction distance.

According to a feature in accordance with the disclosure, operation b) is preferably performed following operation b1) by moving the lower front hinge axis in the rearward direction, the lower rear hinge axis being fixed.

According to a further feature in accordance with the disclosure, the method preferably further comprises operation c), moving the second element of the slideway relative to the first element in the longitudinal direction in the forward direction to the forward end position.

According to an additional feature according to the disclosure, operation c) is preferably carried out prior to operation b).

According to another feature in accordance with the disclosure, operation b) is preferably performed following operation b2) by moving the lower rear hinge axis in the forward direction, the lower front hinge axis being fixed.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 shows a perspective view of a seat in the usage configuration and in an extreme rear position;

FIG. 2 shows a side view of the seat in the usage configuration and in the extreme rear position;

FIG. 3 shows a side view of the seat in the front end position;

FIG. 4 shows a side view of the seat in an intermediate configuration;

FIG. 5 shows a side view of the seat in an intermediate configuration; and

FIG. 6 shows a side view of the seat in an emergency configuration.

### DETAILED DESCRIPTION

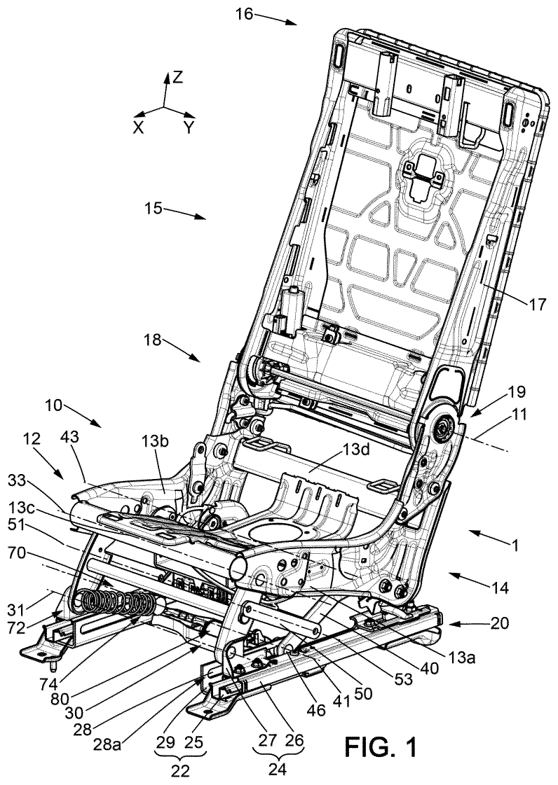

FIGS. 1 to 6 show a seat 1. The seat 1 is a vehicle 100 seat, in particular a car seat. The seat 1 is located in a passenger compartment 4 of the vehicle 100. The seat 1 comprises a squab 10, a backrest 15, a hinge 19, a pair of slideways 20 and an actuator 80. The seat 1 further comprises, between each slideway 20 and the squab 10, a front connecting rod 30, a rear connecting rod 40, a linking rod 50, a latch 60 and an elastic element 70.

The squab 10 extends in a longitudinal direction X between a front edge 12 and a rear edge 14. In the shown embodiment, the squab 10 comprises a squab frame 13. The squab frame 13 comprises two longitudinal members 13a, 13b connected by a front cross-member 13c and a rear cross-member 13d. The longitudinal members are arranged on either side of the seat in a transverse direction Y, perpendicular to the longitudinal direction X. The longitudinal members 13a, 13b extend mainly in the longitudinal direction X. The front cross-member 13c and the rear cross-member 13d extend mainly in the transverse direction Y.

The backrest 15 extends in the elevation direction Z between an upper end 16 and a lower end 18. The elevation direction Z is perpendicular to the longitudinal direction X and to the transverse direction Y. The lower edge 18 of the backrest 15 is positioned close to the rear edge 14 of the squab 10.

The backrest 15 comprises a backrest frame 17. The backrest frame 17 is connected to each of the longitudinal members 13a, 13b by a hinge 19. The hinges 19 are spaced apart in the transverse direction Y and connected to each other to synchronize the movements of each side of the seat in the transverse direction Y. Each hinge 19 has a hinge axis 11 extending in the transverse direction Y. The backrest frame 17 can thus be pivoted about the hinge axis 11 relative to the squab frame 13 via the hinges 19 between a folded position and a reclining position. In the folded position, the backrest 15 extends substantially parallel to the squab 10, above the squab 10, while in the reclining position the backrest 15 extends substantially in line with the squab 10.

The hinges 19 can be either continuous or discontinuous. The continuous type allows the inclination of the backrest frame 17 to be adjusted relative to the squab frame 13, in any position between the folded position and the reclining position. The setting is virtually irreversible, so that the set position is locked. The so-called discontinuous type has two states, one allowing the backrest frame 17 to be released relative to the squab, and the other locking the inclination of the backrest frame 17 relative to the squab frame in a finite number of positions, between the folded position and the reclining position.

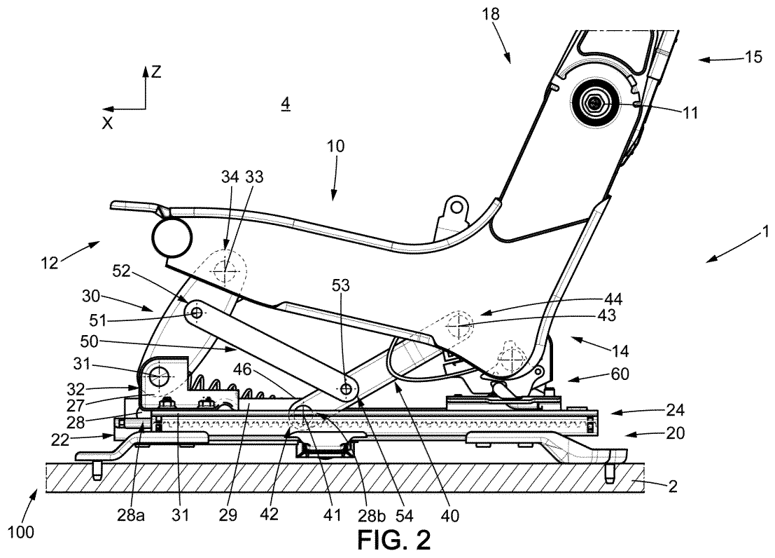

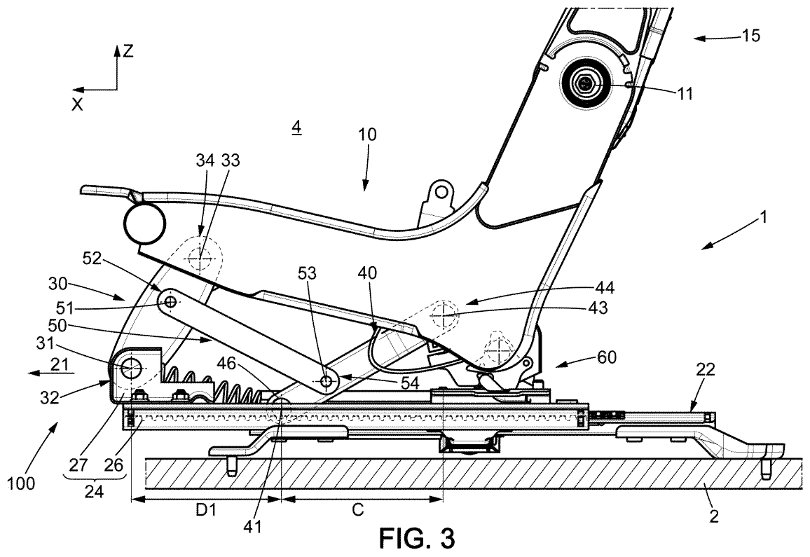

The squab 10 is supported by the pair of slideways 20. This slideway 20 comprises a first element 22 and a second element 24. The first element 22 is attached to the floor 2 of the vehicle 100. The second element 24 is configured to slide in a longitudinal direction X between a front end position (shown in FIG. 3) and a rear end position (shown in FIGS. 1 and 2), in a forward direction 21 or in a rearward direction 23.

Each slideway 20 can further comprise a latching mechanism to hold the second element 24 relative to the first element 22 along the longitudinal direction X in the rear end position, in the front end position, or in multiple positions between the rear end position and the front end position.

The first element 22 comprises a first rail 25 and a metal sheet 29. The first rail 25, also referred to as the first profile, extends in longitudinal direction X. The metal sheet 29 is attached to the second rail 26. The metal sheet 29 is bent at right angles, so that its cross-section perpendicular to the longitudinal direction X is “L”-shaped. The metal sheet 29 has a substantially horizontal face, by means of which the sheet is rigidly attached to the first rail 25, and a vertical face wherein a slot 28 is formed. The slot 28 extends in the longitudinal direction between a front end 28a and a rear end 28b. The second element 24 comprises a second rail 26 to which other elements, such as a support 27, may be attached. The second rail 26, also referred to as the second profile, extends in the longitudinal direction X and cooperates with the first rail 25. The support 27 is rigidly attached to the second rail 26.

In the shown embodiment, the sliding of the second element 24 relative to the first element 22 is controlled by an actuator 80 comprising an electric motor and a transmission system. The transmission system is preferably irreversible (such as a worm gear), so the latching mechanism is optional.

In the shown embodiment, the seat 1 comprises a pair of slideways 20 spaced apart along a transverse direction Y, perpendicular to the longitudinal direction X. The slideways 20 are substantially identical or symmetrical to each other with respect to a median plane perpendicular to the transverse direction Y. Alternatively, the seat 1 could comprise a single slideway 20 arranged substantially in the middle of the seat 1 along the transverse direction Y.

Each of the slideways 20 is connected to one of the longitudinal members 13a, 13b by the front connecting rod 30, the rear connecting rod 40, the linking rod 50, the latch 60 and the elastic element 70.

Each front connecting rod 30 with a lower front end 32 and an upper front end 34. In the vicinity of the lower front end 32, each front connecting rod 30 is rotatably mounted on the second element of the slideway 24 about a lower front hinge axis 31, more precisely on the support 27. Alternatively, each front connecting rod 30 could be rotatably mounted about the lower front hinge axis 31 on the second rail 26. In the vicinity of the front edge 12 of the squab 10 and the upper front end 34 of the front connecting rod 30, the squab 10 is rotatably mounted about an upper front hinge axis 33 on each front connecting rod 30. The lower front hinge axis 31 and the upper front hinge axis 33 extend in the transverse direction Y.

Each rear connecting rod 40 has a lower front end 32 and an upper front end 34. In the vicinity of the rear edge 14 of the seat 30 and the upper rear end 44 of the rear connecting rod 40, the squab 10 is rotatably mounted about an upper rear hinge axis 43 on each rear connecting rod 40. In the vicinity of the lower rear end 42, each rear connecting rod 40 is rotatably mounted about a lower rear hinge axis 41 on the second element of the slideway 24, and the lower rear hinge axis 31 is movable in the longitudinal direction X. The lower rear hinge axis 41 and the upper rear hinge axis 43 extend in the transverse direction Y. More precisely, in the vicinity of the lower rear end 42, the rear connecting rod 40 is mounted on the first element 22 by means of a slider 46. The slider 46 can translate in the slot 28 along the longitudinal direction X between the front end 28a and the rear end 28b. In the shown embodiment, the slider 46 is rotationally symmetrical about the lower rear hinge axis 31, so that the slider 46 can freely rotate relative to the slot 28 about the lower rear hinge axis 31. Alternatively, the slider 46 could be prevented from rotating about the lower rear hinge axis 31, with the rear connecting rod 40 pivotably mounted on the slider 46 about the lower rear hinge axis 31.

Each linking rod 50 has an intermediate front end 42 and an intermediate rear end 54. In the vicinity of the intermediate front end 52, each linking rod 50 is rotatably mounted on the front connecting rod 30 about an intermediate front hinge axis 51. In the vicinity of the intermediate rear end 54, each linking rod 50 is rotatably mounted on the rear connecting rod 40 about an intermediate rear hinge axis 53. The intermediate front hinge axis 51 and the intermediate rear hinge axis 53 extend in the transverse direction Y.

In the shown embodiment, the elastic element 70 is a tension spring. The elastic element 70 has a front loading end 72 and a rear loading end 74, the front loading end 72 is connected to the lower front hinge axis 31 and the rear loading end 74 is connected to the lower rear hinge axis 41. In this way, the elastic element 70 forces the slider 46 in the slot 28, and therefore the lower rear hinge axis 41, to move forward 21 in the longitudinal direction X.

Each latch 60 is arranged between one of the longitudinal members 13a, 13b and one of the second elements 24. Each latch 60 comprises a bolt 62 and a keeper 64. The bolt 62 is rotatably mounted on the squab frame 13 about a bolt axis 61. The keeper 64 is attached to the second element 24. The latch 60 has an active state and an inactive state. In the active state, the bolt 62 is in a latching position, at least partially received in the keeper 64, to secure the squab frame 13, in the vicinity of the rear edge 14, and the second element 24. Here, a single control member 66 is used to synchronously unlatch the two latches 60. For example, the bolt 62 is resiliently biased towards the latching position and control member 66 is used to control the rotation of the bolt 62 about bolt axis 61 towards an unlatching position corresponding to the inactive state of the bolt 60, wherein the bolt 62 is released from the keeper 64. Alternatively, the bolt 62 can be resiliently biased towards the unlatched position, the control member 66 holds the bolt 62 in the latched position by preventing the pivoting of the bolt 62 about the bolt pin 61, the control member 66 can retract to allow the bolt 62 to pivot towards the unlatched position.

In the operating configuration shown in FIGS. 1 to 3, the latch 60 is in the active state and the squab 10 is attached to the second element 24 by the latch 60, front connecting rod 30, rear connecting rod 40, and linking rod 50. Unless otherwise indicated below, the second element 24 can be translated forward 21 (relative to the first element 22) by the actuator 80 along the longitudinal direction X, from the rear end position shown in FIGS. 1 and 2 to the forward end position shown in FIG. 3. When the second element 24 is in the rear end position, the slider 46 is at the rear end 28b of the slot 28. When the second element 24 is in the front end position, the slider 46 is at the front end 28a of the slot 28. Conversely, the second element 24 can be translated rearward 23 (relative to the first element 22) by the actuator 80 along the longitudinal direction X, from the front end position shown in FIG. 3 to the rear end position shown in FIGS. 1 and 2. Of course, the second element 24 can be stopped in the forward direction 21 before reaching the forward end position and in the rearward direction 23 before reaching the rearward end position, depending on the seat user's command. In particular, the user can use comfort control buttons to move the second element 24 forward 21 or rearward 23 and stop the movement in their desired position.

The seat 1 may, for example, be a front seat of a motor vehicle with three doors. A door can be arranged longitudinally at the seat 1. The motor vehicle may be devoid of a door arranged longitudinally at the rear seat. According to another variant, the seat 1 may be a seat of a second row of seats, in particular in a vehicle with five doors comprising three rows of seats. In the operating configuration shown in FIGS. 1 to 3, the seat 1 prevents an occupant of a rear seat, positioned longitudinally behind the seat 1, from exiting the vehicle.

When the user wishes to bring the seat from the usage configuration into a retracted configuration, specifically an easy entry configuration, they carry out an easy entry command.

The seat then performs an operation c) wherein the actuator 80 moves the second element 24 relative to the first element 22 forward 21 along the longitudinal direction X to the forward end position. The slider 46 then moves through the slot 28 to the front end 28a, as shown in FIG. 3. The lower front hinge axis 31 is spaced from the lower rear hinge axis 41 by a first distance D1 in the longitudinal direction X.

Then, in operation a), the latch 60 changes from active to inactive.

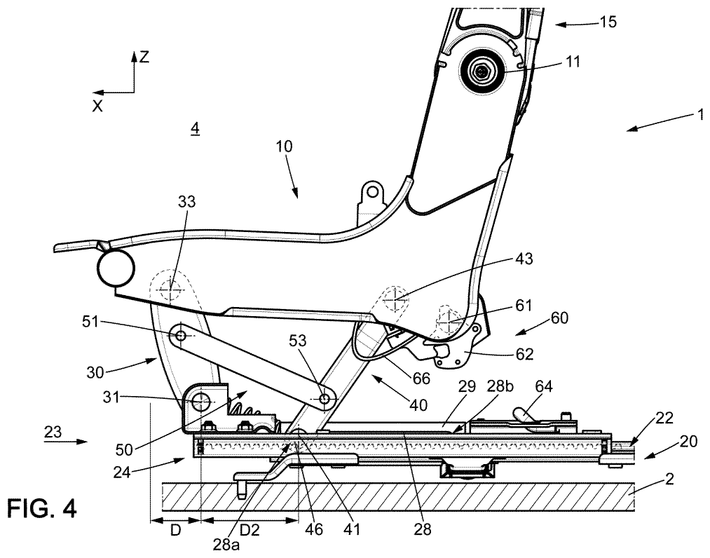

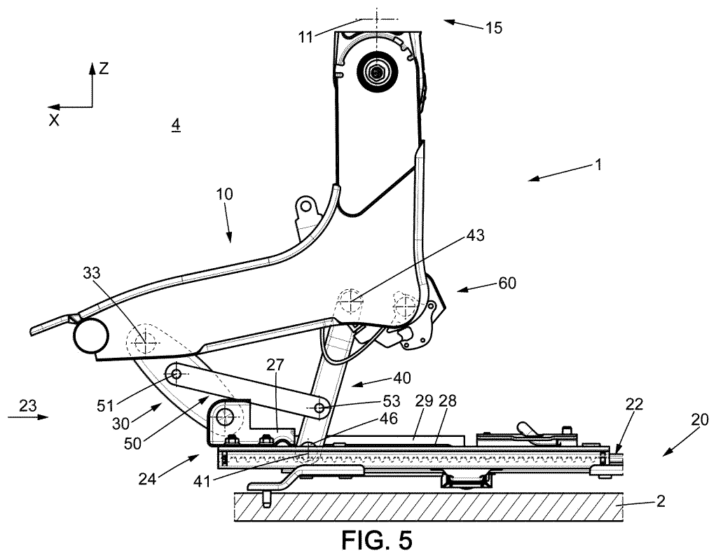

The elastic element 70 then urges the lower rear hinge axis 41 to move in the forward direction 21. However, the front end 28a of slot 28 acts as a stop, preventing the slider 46 and therefore the lower rear hinge axis 41 from moving. An operation b) bringing the lower front hinge axis 31 closer to the lower rear hinge axis 41 then takes place according to operation b1). During operation b1), the actuator moves the second element 24 relative to the first element 22 in the rearward direction 23 by a retracting distance D. The lower front hinge axis 31 is at that point separated from the lower rear hinge axis 41 by a second distance D2 along the longitudinal direction X. The first distance D1 is equal to the sum of the second distance D2 and the retraction distance D. As shown in FIGS. 4 and 5, under the action of the elastic element 70, the lower rear hinge axis 41 remains in abutment against the front end 28a of the slot 28, while the lower front hinge axis 31 approaches the lower rear hinge axis 41 by moving in the rearward direction 23. In FIG. 5, the second element 24 is in an extreme forward setting position relative to the first element 22.

The seat 1 then moves to a retracted configuration, more precisely to an easy entry configuration, by a retracting movement of the rear edge 14 of the squab 10 comprising a component in the forward direction 31 along the longitudinal direction X and a component along the elevation direction Z consisting of a movement of the rear edge 14 of the squab 10 away from the second element 24.

Alternatively, the operation a) may not be subsequent to the operation c), and the operation a) may even be prior to operation c). In this case, the operation c) can be completed when the slider 46 is in abutment with the front end 28a of the slot 28.

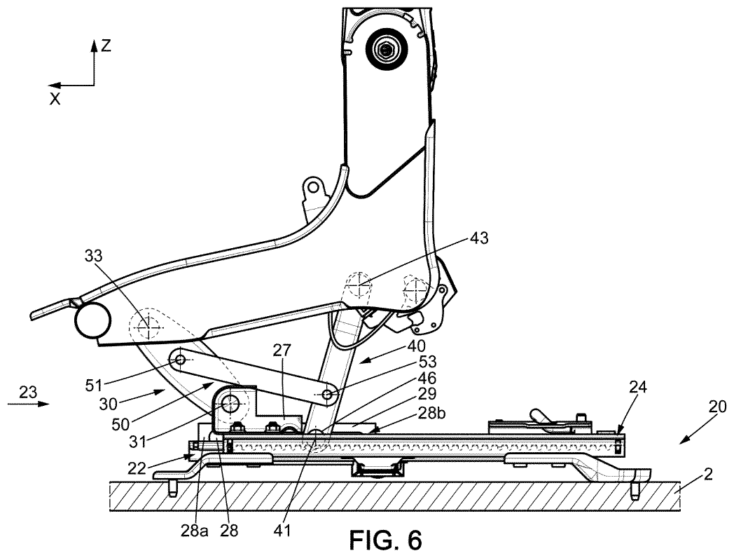

The user can also perform an emergency command. The emergency command is intended to be triggered by the user in place of the easy entry command, in the event of failure of the actuator 80 or in an emergency. In the event of an emergency command, the operation c) is not performed, the operation a) is performed first, then operation b) bringing the lower front hinge axis 31 closer to the lower rear hinge axis 41 is performed according to operation b2). As shown in FIG. 6, following the operation a), the latch is in the inactive state, as the operation c) has not been performed, the slider 46 is away from the front end position and as the elastic element 70 urges the lower rear hinge axis 41 closer to the lower front hinge axis 31 along the longitudinal direction X, the lower rear hinge axis 41 moves forward 21. The seat 1 then changes to a retracted configuration, more precisely to an emergency configuration, by a retracting movement of the rear edge 14 of the squab 10, also comprising a forward component 31 (less than in the case of the change to the easy entry configuration) along the longitudinal direction X and a component (identical to the case of the change to the easy entry configuration) along the elevation direction Z consisting of a movement of the rear edge 14 of the squab 10 away from the second element 24.

In order to provide that, in the case of emergency operation, the retracting movement is not interrupted by the slider 46 coming into abutment against the front end 28a of the slot 28, the actuator 80 is configured to limit the forward movement 21 of the second element 24 relative to first element 22 to the extreme forward setting position shown in FIG. 5, in the in-use configuration.

In the automotive field, in particular, a comparative vehicle seat maybe configured to be able to have a usage position and a position that facilitates access to the spaces located behind the seat (referred to hereinafter as “easy entry position”). Such a comparative seat may be implemented in a vehicle comprising a number of pairs of doors that is smaller than the number of rows of seats in order to allow access to the last row of seats in the vehicle, that is to say, to the row of seats arranged longitudinally furthest to the rear of the vehicle.

In the easy entry configuration, the comparative seat is tilted forward and generally in a forward position. The comparative seat may be mounted on slideways. In this case, the easy entry position can advantageously also correspond to a position of the comparative seat that is as far forward as possible, along the slideways.

Such a comparative seat is satisfactory, the present disclosure aims to offer a different solution that is robust, simple and inexpensive.

In accordance with the disclosure, a vehicle seat is proposed, comprising:
a squab with a front edge and a rear edge,
a slideway comprising a first element and a second element, the first element being intended to be fixed to a vehicle floor and the second element being configured to slide relative to the first element in a longitudinal direction between a forward end position and a rearward end position, in a forward direction or in a rearward direction, opposite to the forward direction,
a front connecting rod with a lower front end and an upper front end,
a rear connecting rod with a lower rear end and an upper rear end,
a linking rod with an intermediate front end and an intermediate rear end,
a latch having an active state and an inactive state, in a usage configuration of the seat the latch is in the active state and holds the squab relative to the second element of the slideway at least along the longitudinal direction, in the inactive state the latch does not hold the squab relative to the second element of the slideway,
an elastic element,
wherein:
in the vicinity of the lower front end, the front connecting rod is rotatably mounted about a lower front hinge axis on the second element of the slideway,
in the vicinity of the upper front end, the squab is rotatably mounted on the front connecting rod about an upper front hinge axis,
in the vicinity of the lower rear end, the rear connecting rod is rotatably mounted on the first element about a lower rear hinge axis, and the lower rear hinge axis is movable in the longitudinal direction,
in the vicinity of the upper rear end, the squab is rotatably mounted on the rear connecting rod about an upper rear hinge axis,
in the vicinity of the intermediate front end, the linking rod is rotatably mounted on the front connecting rod about an intermediate front hinge axis,
in the vicinity of the intermediate rear end, the linking rod is rotatably mounted on the rear connecting rod about an intermediate rear hinge axis,
the lower front hinge axis, the upper front hinge axis, the lower rear hinge axis, the upper rear hinge axis, the intermediate front hinge axis and the intermediate rear hinge axis extend in a transverse direction, perpendicular to the longitudinal direction,
the elastic element urges the lower rear hinge axis to move forward along the longitudinal direction,
the seat is configured to switch from the usage configuration to a retracted configuration after switching from the active state to the inactive state of the latch, by a retracting movement of the rear edge of the seat, moving the lower front hinge axis closer to the lower rear hinge axis over a retracting distance, the retracting movement comprising a forward component in the longitudinal direction.

According to a further feature in accordance with the disclosure, preferably the retracting movement comprises a rear seat access movement, the seat is configured to perform the rear seat access movement by sliding the second element from the front end position over the retraction distance in the rearward direction relative to the first element, while keeping the lower rear hinge axis along the longitudinal direction.

As a result, the slideway is not in the extreme forward position in the retracted configuration, which improves the slideway's robustness.

According to a further feature in accordance with the disclosure, the seat preferably further comprises a single actuator configured to, in the usage configuration, translate the squab in the forward direction and in the rearward direction, opposite to the forward direction, by moving the second element along the longitudinal direction, and cause the retracting movement of the rear edge of the squab by moving the second element in the rearward direction, when the latch is in the inactive state.

In this way, a single actuator can be used to set the usage configuration and the retracting movement.

According to a complementary feature in accordance with the disclosure, the seat is preferably configured so that the transition from the active to the inactive state of the latch allows emergency movement of the rear edge of the squab, by moving the lower rear hinge axis in the forward direction along the longitudinal direction while maintaining the second element relative to the first element.

In this way, even in the event of actuator failure, the seat can be placed in the retracted configuration.

According to a still further feature in accordance with the disclosure, preferably the slideway has a sliding stroke between the front end position and the rear end position, and the actuator is configured to limit the movement of the second element relative to the first element, in the usage configuration, between the rear end position and a front end setting position, the front end setting position being between the front end position and the rear end position and spaced from the front end position by the retracting distance.

In this way, whatever setting the user sets in the usage configuration, the seat can be placed in the retracted configuration, even if the actuator fails.

In various embodiments of the seat according to the disclosure, any of the following arrangements may also be employed:
the elastic element has a front loading end and a rear loading end, the front loading end is connected to the lower front hinge axis and the rear loading end is connected to the lower rear hinge axis;
in the active state, the latch holds the squab in the vicinity of the rear edge, relative to the second element;
the seat further comprises a backrest and a hinge, the backrest is connected to the squab by the hinge, the hinge has a hinge axis and is rotationally lockable, the hinge axis extends in the transverse direction in the vicinity of the rear edge;
the retracting movement further comprises moving the rear edge of the squab away from the slideway, in an elevation direction perpendicular to the longitudinal direction and the transverse direction;
the first element has a slot extending in the longitudinal direction, a slider is slidably mounted in the slot, and the rear connecting rod is mounted on the first element via the slider;
the slot (28) has a front end (28a) forming a stop, and
in the operating configuration, in the extreme front position, the slider is in abutment with the front end of the slot;
the upper front hinge axis is close to the front edge of the seat, and the upper rear hinge axis is close to the rear edge of the seat.

The present disclosure also relates to a method of using the aforementioned seat, the method comprising, starting from the usage configuration, the following operations:
a) switching from the active to inactive state of the latch, then
b) moving the lower front hinge axis closer to the lower rear hinge axis by the retraction distance.

According to a feature in accordance with the disclosure, operation b) is preferably performed following operation b1) by moving the lower front hinge axis in the rearward direction, the lower rear hinge axis being fixed.

According to a further feature in accordance with the disclosure, the method preferably further comprises operation c), moving the second element of the slideway relative to the first element in the longitudinal direction in the forward direction to the forward end position.

According to an additional feature according to the disclosure, operation c) is preferably carried out prior to operation b).

According to another feature in accordance with the disclosure, operation b) is preferably performed following operation b2) by moving the lower rear hinge axis in the forward direction, the lower front hinge axis being fixed.

A vehicle seat (1) comprising a squab (10), a slideway (20), a front connecting rod (30), a rear connecting rod (40), a linking rod (50), a latch (60) and an elastic element (70), wherein: the slideway (20) comprises a first element (22) and a second element (24), the front connecting rod (30) is rotatably mounted on the second element of the slideway (24) about a lower front hinge axis (31), the rear connecting rod (40) is rotatably mounted on the first element (22) about a movable lower rear hinge axis (41), the linking rod (50) is rotatably mounted on the front connecting rod (30) and on the rear connecting rod (40), the elastic element (70) urges the lower rear hinge axis (41) to move, the seat (1) is configured to move to a retracted configuration by moving the lower front hinge axis (31) closer to the lower rear hinge axis (41).

1. A vehicle seat (1) comprising:
a squab with a front edge and a rear edge,
a slideway comprising a first element and a second element, the first element being intended to be fixed to a vehicle floor and the second element being configured to slide relative to the first element in a longitudinal direction between a forward end position and a rearward end position, in a forward direction or in a rearward direction, opposite to the forward direction,
a front connecting rod having a lower front end and an upper front end,
a rear connecting rod with a lower rear end and an upper rear end,
a connecting rod with an intermediate front end and an intermediate rear end,
a latch having an active state and an inactive state, in a usage configuration of the seat, the latch is in the active state and holds the squab relative to the second element of the slideway at least along the longitudinal direction, in the inactive state the latch does not hold the squab relative to the second element of the slideway,
an elastic element,
wherein:
in the vicinity of the lower front end, the front connecting rod is rotatably mounted on the second element of the slideway about a lower front hinge axis, in the vicinity of the upper front end, the squab is rotatably mounted on a front connecting rod about an upper front hinge axis,
in the vicinity of the lower rear end, the rear connecting rod is rotatably mounted on the first element about a lower rear hinge axis, and the lower rear hinge axis is movable in the longitudinal direction,
in the vicinity of the upper rear end, the squab is rotatably mounted on the rear connecting rod about an upper rear hinge axis,
in the vicinity of the intermediate front end, the linking rod is rotatably mounted on the front connecting rod about an intermediate front hinge axis,
in the vicinity of the intermediate rear end, the linking rod is rotatably mounted on the rear connecting rod about an intermediate rear hinge axis,
the lower front hinge axis, the upper front hinge axis, the lower rear hinge axis, the upper rear hinge axis, the intermediate front hinge axis and the intermediate rear hinge axis extend in a transverse direction, perpendicular to the longitudinal direction,
the elastic element urges the lower rear hinge axis to move forward in the longitudinal direction,
the seat is configured to switch from the usage configuration to a retracted configuration after switching from the active state to the inactive state of the latch, by a retracting movement of the rear edge of the squab, moving the lower front hinge axis closer to the lower rear hinge axis over a retracting distance, the retracting movement comprising a forward component in the longitudinal direction.

2. The seat according to claim 1, wherein the retracting movement comprises a rear seat access movement, the seat is configured to perform the rear seat access movement by sliding the second element from the front end position over the retraction distance in the rearward direction relative to the first element, while keeping the lower rear hinge axis along the longitudinal direction.

3. The seat according to claim 1, wherein the seat further comprises a single actuator configured to:
in the usage configuration, translate the squab in the forward direction and in the rearward direction, opposite to the forward direction, by moving the second element in the longitudinal direction, and
cause the rear edge of the squab to retract by moving the second element in the rearward direction, when the latch is in the inactive state.

4. The seat according to claim 3, wherein the seat is configured so that switching from the active state to the inactive state of the latch allows an emergency movement of the rear edge of the squab, by forward movement of the lower rear hinge axis in the longitudinal direction while maintaining the second element relative to the first element.

5. The seat according to claim 3, wherein:
the slideway has a sliding stroke between the front end position and the rear end position, and
the actuator is configured to limit the movement of the second element relative to the first element, in the usage configuration, between the rear end position and a front end setting position, the front end setting position being between the front end position and the rear end position and spaced from the front end position by the retraction distance.

6. The seat according to claim 1, wherein the elastic element has a front loading end and a rear loading end, the front loading end is connected to the lower front hinge axis and the rear loading end is connected to the lower rear hinge axis.

7. The seat according to claim 1, wherein:
the first element has a first slot which extends in the longitudinal direction,
a slider is slidably mounted in the slot, and
the rear connecting rod is mounted on the first element via the slider.

8. A method for using the seat of claim 1, the method comprising, starting from the usage configuration, the following operations:
a) switching from the active to inactive state of latch, then
b) moving the lower front hinge axis closer to the lower rear hinge axis by the retraction distance.

9. The method according to claim 8, wherein the operation b) is carried out following the operation b1) by moving the lower front hinge axis rearward, the lower rear hinge axis being fixed.

10. The method according to claim 8, wherein the method further comprises a step c), of moving the second element of the slideway relative to the first element forward along the longitudinal direction to the forward end position.

11. The method according to claim 10, wherein the operation c) is carried out prior to the operation b).

12. The method according to claim 8, wherein the operation b) is carried out according to the operation b2) by moving the lower rear hinge axis forward, the lower front hinge axis being fixed.
